(19) United States
(12) Patent Application Publication
(10) Pub. No.: US 2004/0053575 A1
(43) Pub. Date: Mar. 18, 2004

(54) Portable electronic device

(76) Inventors: Rainer Eckert, Bad Neustadt/Herschfeld (DE); Helmut Funfgelder, Dietersheim (DE); Lothar Mamier, Munchen (DE); Zibert Klaus, Muenchen (DE)

Correspondence Address: BELL, BOYD & LLOYD, LLC, P. O. BOX 1135, CHICAGO, IL, 60690-1135, US

(21) Appl. No.: 10/415,159

(22) PCT Filed: Oct. 1, 2001
(86) PCT No.: PCT/DE01/03758

(30) Foreign Application Priority Data
Oct. 25, 2000 (DE) 100 52 906.2

(51) Int. Cl. H04B 1/10; H04B 15/00

(52) U.S. Cl. 455/63.1

(57) ABSTRACT

Portable electronic device which is sensitive vis-à-vis interferences as a result of the transmit mode of a mobile radio terminal device, particularly a hearing aid, audio device or hand held PC, with a high-frequency interference suppression device (15; 37; 40; 60) which has a high-frequency detector device (45; 65) for detecting a high-frequency transmission signal of a close mobile radio terminal device (17) and a switching element (49) or control element (67) which is connected to the high-frequency detector device at the input side and to a control input or power supply input (9) of the device for at least partially deactivating the device.

The invention relates to a portable electronic device according to the preamble of claim 1.

In recent years, the mobile communication has shown a dynamic, which is unusual for a new technical development, and has become an important factor of everyday life in the developed industrial nations. It is conceivable that the majority of all adults will have a mobile telephone and will use it with increasing frequency in a few years. The offer of new services—particularly information services, as well as trade services, game possibilities etc, also contributes thereto. This leads to a clear increase in the average daily time that users use the mobile radio terminal devices.

In the course of these developments, the circumstance is of increasing importance that a series of portable electronic devices, particularly miniature radio devices and hearing aids, as well as portable CD players and DAD players, MP3 players and organizers or, respectively, hand held PC's are exposed to considerable disturbances due to the transmit mode of a mobile radio terminal device operated nearby.

Said disturbances are perceived as acoustically clear and possibly severely disturbing background noise with respect to audio devices and hearing aids or are disturbances regarding the function of process-controlled miniature devices. Particularly apparent is this effect with respect to radios that are worn at the body, miniature radios in headphones, hearing aids or mobile radio-radio combination devices. Background noise does not only occur during the telephoning but also in the course of connections that are independently set up between the mobile radio terminal device and the base station in the framework of a “location update”.

Therefore, an object of the invention is to propose an improved device wherein such disturbances do not have disadvantageous effects on the functions of the device and/or wherein a disturbance that is disturbing for the user does not occur.

This object is achieved by a device having the features of claim 1.

The invention includes the idea of independently drastically reducing the disturbances, which are expected as a result of a mobile radio terminal device operated close to the device, by at least partially deactivating or, respectively, reducing the audio performance of the device in question given full function of the device to be protected. For this purpose, a high-frequency detector device is used for the reliable detection of the outputted transmitting power, whereby said detection is independent of an active use of the mobile radio terminal device. This high-frequency detector device is at least indirectly connected to the input of a switching device or, respectively, control device affecting the aforementioned partial or complete deactivation or, respectively, power reduction.

As a result, the user of the mobile radio terminal device, as well as of the additional electronic device or, respectively, the user of the other relevant device, which is close to the user of a mobile telephone, does not have to turn off his/her device. The proposed solution is immediately effective with respect to the start of the transmit mode of the mobile radio terminal device, so that a disturbance will not occur in the surroundings in the first place. Said invention is also effective regarding automated transmission processes of mobile radio terminal devices, whereby the user is not prepared for said transmission processes which normally trigger such temporary disturbances, so that it would not be advantageous for the user to turn off the device.

After the reaction time, the disturbance is mostly gone—which does not mean that it is not perceived as highly disturbing during its short while.

In a preferred embodiment of the invention, the device has a switch for turning off or muting the entire device or its low frequency part or at least one loudspeaker output or headphone output. In this way, acoustically perceivable disturbances concerning an audio device, such as a hearing aid, radio, CD player, walk man etc., are effectively suppressed. There are practically no consequences when such devices are completely switched off, depending on the concrete device concept, or a complete switching-off can be tolerated concerning its consequences. As long as this is not the case, an acoustic manifestation of the disturbance can be prevented, without eliminating its effect on the device itself, by turning off only one loudspeaker output or headphone output or by muting only one loudspeaker output or headphone output.

In another embodiment, a control element is provided for significantly reducing the low frequency output power, so that the disturbing effect of the disturbance can be mostly suppressed. This can be the most advantageous solution for a hearing aid, for example, since the acoustic perception of the user is not entirely interrupted and the reception of critical bits of information via the hearing, on principle, remains possible. Particularly with respect to a portable device that is fashioned as a radio or a device having such a radio, a mute input is mostly present which can be simultaneously used for the signal of the high-frequency detector device and which mutes the radio for the duration of the disturbance in the sense of the aforementioned embodiment.

For a processor-operated portable device such as an organizer, highly developed pocket translators or hand held PC's, the electromagnetic radiated interference originating from the mobile radio device can induce critical malfunctions. For this purpose, a preferred embodiment of the invention provides a switch for deactivating the processor or, respectively, controller. As a result, the device is heavily protected against malfunctions.

The high-frequency detector device particularly has an inductive coupling link for coupling-in the high-frequency radiated interference. In a first embodiment, such a coupling link can have a line that is arranged at or close to the outside wall of the device or can have taped [or: rolled, ?] inactivity which, with only low selectivity, practically couples-in all relevant high-frequency radiated interferences in the spatial region of the device - and therefore also the high-frequency radiation of a mobile radio terminal device.

As an alternative, an antenna is provided which is highly selective regarding the mobile radio transmission frequency range. In particular, this can be a ceramic patch antenna as it is used for mobile radio terminal devices themselves. Such a coupling link is as specifically adapted to the radiated interference originating from a mobile radio terminal device as a high-frequency detector device which has a band-pass filter device tailored to the corresponding frequency range and is fashioned as a surface wave filter, in particular.

In a simple and inexpensive and therefore preferred embodiment, the core piece of the high-frequency detector device is a high-frequency detector diode.

In another expedient embodiment, the high-frequency detector device has a threshold discriminator for comparing the detected radiated interference power to a predetermined threshold that can be expediently adjusted via a corresponding adjustment element. A switching function or, respectively, controlling function concerning the portable device is only triggered when the threshold (which reflects a specific measure of manifest acoustic interference or, respectively, malfunction) is exceeded.

The switching device or, respectively, control device is expediently fashioned such that it independently reactivates the relevant device or, respectively, its deactivated component(s) or, respectively, restores the original power level given an input signal on the side of the high-frequency detector device indicating the end of the disturb signal.

In a first alternative, the structure of the device is characterized by an integration of the high-frequency detector device and of the switching element or, respectively, control element with [sic] the actual device, whereas, in a second alternative, at least the high-frequency detector device, preferably also the switching device or, respectively, control device, is fashioned as an independent additional device for a device that is already present as such. Normally it will also have a separate housing or at least a separate encapsulation.

Advantages and purposes of the invention derive from the subclaims and the following explanation of a preferred embodiment on the basis of the Figures.

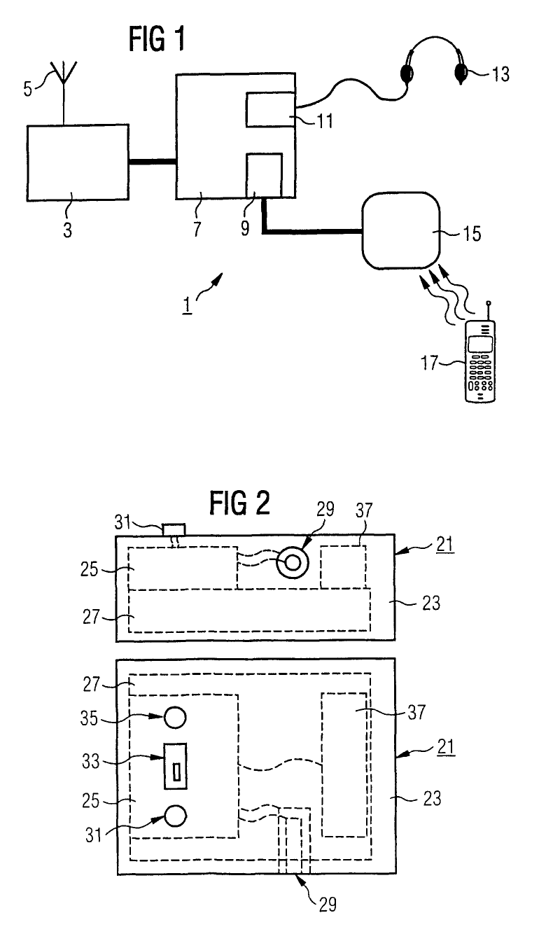

FIG. 1 shows a schematic diagram of an arrangement composed of a portable radio according to an embodiment of the invention and a mobile telephone,

FIG. 2 shows a schematic diagram of the construction of the (modified) radio used in such an arrangement,

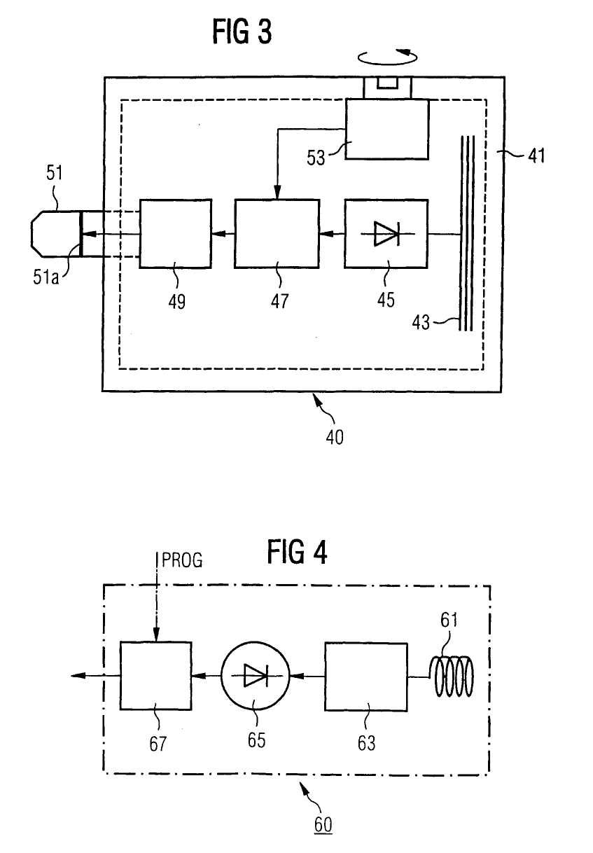

FIG. 3 shows a block diagram of a high-frequency interference suppression component for a portable electronic device according to a first embodiment of the invention and

FIG. 4 shows a block diagram of a high-frequency interference suppression component for a portable electronic device according to a second embodiment of the invention.

A radio-mobile radio arrangement 1 according to FIG. 1 has—highly simplified for explaining the invention—a radio receiver part 3 with a radio reception antenna 5, an audio amplifier or, respectively, low frequency amplifier 7, which is connected to the output of the radio reception part 3 and which has a mute input 9 and a headphone output 11 and a headphone 13 connected to it. A high-frequency interference suppression component 15 (fashioned as a separate additional part in this case) is connected to the mute input 9 and detects the radiated interference originating from a mobile radio telephone in transmit mode; if such radiated interference has been detected, said high-frequency suppression component 15 mutes the audio amplifier 7 or, respectively, its headphone output 11, or drastically reduces the low frequency power level.

In a side view and plan view, FIG. 2 (modified vis-à-vis FIG. 1) schematically shows the construction of a portable radio 21 with integrated high-frequency interference suppression. In a radio housing 23, the radio 21 has a radio switching board 25, which is arranged above an accumulator compartment or, respectively, battery compartment 27, a headphone jack 29, an on/off switch 31, a volume controller 33 and a transmit search key 35 as operating elements. In addition to the radio switching board 25, an integrated high-frequency suppression component 37 is placed above an accumulator compartment or, respectively, battery compartment 27. The radio antenna (not shown) can serve as a common high-frequency coupling element 61 for the radio and the high-frequency interference suppression component 37.

FIG. 3 shows a high-frequency interference suppression component 40 as a separate accessory for a use as shown in FIG. 1. At the surface of a plastic encapsulation 41, it has a high-frequency antenna 43, which is selective regarding the mobile radio frequency ranges and which is connected to an input of a detector circuit 45. The output of said detector circuit 45 is connected to the input of a threshold discriminator 47 which compares the output signal of the detector circuit 45 with a predetermined threshold value and, dependent on the comparison result, it[?] outputs a control signal via its output to a switching element which is connected, with a switching contact 51a, to a terminal pin 51.

An adjustment element 53 is allocated to the threshold discriminator 47, so that the user can adjust the threshold value. Therefore, said user can adjust the switching behavior of the high-frequency interference suppression component 40 to the concrete output power of his/her mobile telephone and to his/her personal needs regarding the mobile telephone interference suppression.

In another embodiment, FIG. 4 shows a high-frequency suppression component 60 which is provided for the integration into a portable electronic device and which does not have a separate housing.

It has a high-frequency coupling element 61 which is fashioned as taped[?] inactivity and which is followed by a band-pass f filter 63 whose output is connected to the actual high-frequency sensor 65. Said high-frequency sensor 65 itself has a predetermined threshold value characteristic and therefore replaces the combination of detector circuit and discriminator circuit as shown in FIG. 3 (the threshold value, however, cannot be adjusted). Its output is connected to the input of a control circuit 67 whose initial characteristic can be adjusted to the concrete use of the interference suppression component 60 by programming during the manufacturing process and which, given response regarding the output signal of the detector 65 when high-frequency radiated interference has been detected, provides a switch-off signal and, when the radiated interference drops below the threshold that is implemented in the detector 65, supplies a switch-on-again signal to a suitable control point of the device in which the interference suppression component 60 is installed.

The implementation of the invention is not limited to the above-described examples and emphasized aspects but, in the framework of the claims, is also possible with respect to a number of modifications.

1. Portable electronic device which is sensitive vis-à-vis interferences as a result of the transmit mode of a mobile radio terminal device, particularly a hearing aid, audio device or handheld PC, characterized by a high-frequency interference suppression device (15; 37; 40; 60) which has a high-frequency detector device (45; 65) for detecting a high-frequency transmission signal of a close mobile radio terminal device (17) and a switching element (49) or control element (67) which is connected to the high-frequency detector device at the input side and to a control input or power supply input (9) of the device for at least partially deactivating the device.

2. Device according to claim 1, characterized by a switch (49; 67) for turning-off or muting the device or at least one loudspeaker output or a headphone output of said device.

3. Device according to claim 1 or 2, characterized by a control element for significantly reducing the low frequency output power given the detection of a high-frequency transmission signal.

4. Device according to one of the previous claims, particularly claim 2 or 3, characterized in that the device is fashioned as a radio (3 to 13; 21) and the high-frequency interference suppression device (15) is connected to a mute input (9) of same.

5. Device according to one of the previous claims, characterized by a switch for deactivating a processor or, respectively, controller device of the device.

6. Device according to one of the previous claims, characterized in that the high-frequency detector device has an inductive coupling link (43; 61), in particular, for coupling-in the high-frequency transmission power.

7. Device according to one of the previous claims, particularly claim 6, characterized in that the coupling link has a line that is arranged at or close to the outside wall of the device or has taped inactivity (61).

8. Device according to one of the previous claim, particularly claim 6, characterized in that the coupling link has an antenna (43), particularly a ceramic patch antenna, which is highly selective regarding at least one transmission frequency range of mobile radio terminal devices, particularly regarding all admitted transmission frequency ranges.

9. Device according to one of the previous claims, characterized in that the high-frequency detector device (45; 65) has a high-frequency detector diode.

10. Device according to one of the previous claims, characterized in that the high-frequency detector device (65) has a filter device (63), particularly a surface wave filter device, which is highly selective regarding at least one transmission frequency range of mobile radio terminal devices, particularly regarding all admitted transmission frequency ranges.

11. Device according to one of the previous claims, characterized in that the high-frequency detector device (45) has a threshold value discriminator (47) for comparing the detected high-frequency transmission signal intensity to a predetermined threshold which ensures that the switching or control element (49) is only activated when the predetermined threshold value of the high-frequency radiated interference power is exceeded.

12. Device according to one of the previous claims, particularly claim 11, characterized in that the threshold value discriminator (47) has a device (53) for adjusting the threshold value.

13. Device according to one of the previous claims, characterized in that the switching or control element (49; 67) is fashioned for restoring the original device function in response to an output signal of the high-frequency detector device (45; 65) indicating the absence of a high-frequency transmission signal.

14. Device according to one of the previous claims, characterized in that the high-frequency interference suppression device (37; 60) are [sic] integrated into a common housing with the device.

15. Device according to one of the claims 1 to 14, characterized in that the high-frequency interference suppression device (15; 40) is fashioned as an additional part that can be externally connected.
